(19) United States
(12) Patent Application Publication
(10) Pub. No.: US 2017/0325100 A1
(43) Pub. Date: Nov. 9, 2017

(54) BASE STATION

(71) Applicant: KYOCERA CORPORATION, Kyoto (JP)

(72) Inventors: Hiroyuki URABAYASHI, Yokohama-shi (JP); Kugo MORITA, Higashiomi-shi (JP); Noriyoshi FUKUTA, Tokyo (JP); Naohisa MATSUMOTO, Higashiomi-shi (JP)

(73) Assignee: KYOCERA CORPORATION, Kyoto (JP)

(21) Appl. No.: 15/660,676

(22) Filed: Jul. 26, 2017

Related U.S. Application Data
(63) Continuation of application No. PCT/JP2016/052106, filed on Jan. 26, 2016.
(60) Provisional application No. 62/109,900, filed on Jan. 30, 2015.

(51) Int. Cl. H04W 16/14; H04W 48/16; H04W 72/04

(52) U.S. Cl. CPC H04W 16/14; H04W 48/16; H04W 72/0413

(57) ABSTRACT

A base station according to an embodiment has a first cell in a licensed band and a second cell in an unlicensed band. The base station comprises: controller configured to execute control to transmit a discovery reference signal in the second cell. The controller executes: control to confirm whether or not there is an available channel in the unlicensed band, before transmitting the discovery reference signal; and control to transmit the discovery reference signal in the available channel in the unlicensed band. The discovery reference signal includes a cell-specific reference signal, a primary synchronization signal, a secondary synchronization signal, and a channel-state-information reference signal.

### RELATED APPLICATIONS

This application is a continuation application of international application PCT/JP2016/052106, filed Jan. 26, 2016, which claims benefit of U.S. Provisional Application 62/109,900, filed Jan. 30, 2015, the entirety of all applications hereby expressly incorporated by reference.

### TECHNICAL FIELD

The present application relates to a base station capable of performing communication in an unlicensed band, a base station capable of performing communication in a licensed band, and a communication apparatus capable of performing communication in the licensed band and the unlicensed band.

### BACKGROUND ART

In 3GPP (3rd Generation Partnership Project), which is a project aiming to standardize a mobile communication system, specifications are being designed to enhance LTE (Long Term Evolution) in order to comply with the rapidly increasing traffic demands (for example, see Non Patent Document 1).

Further, in order to accommodate a rapidly increasing traffic demand, focus is now paid not only to communication using a frequency band that requires a license (licensed band) but also to communication using a frequency band that requires no license (unlicensed band/unlicensed spectrum).

Here, according to a law (for example, Wireless Telegraphy Act in Japan), if a radio signal is transmitted by using an unlicensed band, then it is required to execute a clear channel assessment (CCA) before the radio signal is transmitted. Specifically, a base station measures interference power in the unlicensed band. If the measurement result is good (specifically, if the interference power is low), it is possible to transmit a radio signal in the unlicensed band.

### PRIOR ART DOCUMENT

### Non-Patent Document

Non Patent Document 1: 3GPP technical report “TS 36.300 V12.4.0” Jan. 7, 2015

### SUMMARY

A base station according to an embodiment has a first cell in a licensed band and a second cell in an unlicensed band. The base station comprises: controller configured to execute control to transmit a discovery reference signal in the second cell. The controller executes: control to confirm whether or not there is an available channel in the unlicensed band, before transmitting the discovery reference signal; and control to transmit the discovery reference signal in the available channel in the unlicensed band. The discovery reference signal includes a cell-specific reference signal, a primary synchronization signal, a secondary synchronization signal, and a channel-state-information reference signal.

A base station according to an embodiment is used in a mobile communication system comprising a user terminal capable of performing communication in a licensed band and an unlicensed band. The base station comprises: a controller configured to measure interference power in a predetermined frequency out of a plurality of frequencies available for data transmission and reception in the mobile communication system in the unlicensed band; and a transmitter configured to transmit, based on a measurement result of the interference power, a reference signal. The unlicensed band includes the plurality of frequencies and an unused frequency other than the plurality of frequencies. The transmitter transmits the reference signal in the unused frequency.

A base station according to an embodiment is capable of performing communication, in an unlicensed band, with a user terminal capable of performing communication in a licensed band and the unlicensed band. The unlicensed band includes a plurality of frequency channels. Each of the plurality of frequency channels includes a plurality of frequency resources divided in a frequency direction. The base station includes: a controller configured to measure the interference power in a frequency resource unit; and a transmitter configured to transmit, based on a measurement result of the interference power, a reference signal by using a predetermined frequency resource included in the plurality of frequency resources. The controller notifies the user terminal of resource information indicating the predetermined frequency resource.

A base station according to an embodiment is capable of performing communication, in a licensed band, with a user terminal capable of performing communication in the licensed band and an unlicensed band. The base station comprises: a controller configured to measure interference power in the unlicensed band; and a transmitter configured to transmit, in the unlicensed band, a reference signal. The controller schedules a transmission timing of the reference signal at any timing.

### BRIEF DESCRIPTION OF THE DRAWINGS

FIG. 1 is a configuration diagram of an LTE system according to each embodiment.

FIG. 2 is a block diagram of a UE according to each embodiment.

FIG. 3 is a block diagram of an eNB 200 according to each embodiment.

FIG. 4 is a protocol stack diagram according to each embodiment.

FIG. 5 is a configuration diagram of a radio frame according to each embodiment.

FIG. 6 is a diagram for describing an operation according to a first embodiment.

FIG. 7 is a diagram for describing an operation example 1 of the eNB 200 according to the first embodiment.

FIG. 8 is a diagram for describing the operation example 1 of the eNB 200 according to the first embodiment.

FIG. 9 is a diagram for describing an operation example 2 of the eNB 200 according to the first embodiment.

FIG. 10 is a diagram for describing the operation example 2 of the eNB 200 according to the first embodiment.

FIGS. 11A and 11B are diagrams for describing an operation according to a third embodiment.

FIG. 12 is a diagram for describing an operation according to the third embodiment.

FIG. 13 is a diagram illustrating one example of a transmission frequency of a reference signal according to a fourth embodiment.

FIG. 14 is a diagram illustrating one example of the transmission frequency of the reference signal according to the fourth embodiment.

FIG. 15 is a diagram illustrating one example of the transmission frequency of the reference signal according to the fourth embodiment.

FIG. 16 is a diagram for describing a listen failure before a DRS transmission.

FIG. 17 is a diagram for describing LAA DRS RSRP measurement.

FIG. 18 is a diagram for describing one example of a conventional channel mapping (left) and a proposed channel mapping (right).

### DESCRIPTION OF THE EMBODIMENT

### Overview of Embodiment

It is assumed that in order that a user terminal discovers a cell (base station) in an unlicensed band, the base station transmits a reference signal (discovery reference signal (DRS)) in the unlicensed band. The user terminal may perform measurement for the reference signal to obtain information on a communication environment in between with the cell.

However, if a condition continues where a measurement result of the interference power is poor, the base station is not capable of transmitting the reference signal for a long period of time. As a result, a problem arises that it is not possible to effectively utilize the unlicensed band.

Therefore, an object of the present application is to prevent unavailability where a reference signal cannot be transmitted in an unlicensed band for a long period of time.

A base station according to an embodiment has a first cell in a licensed band and a second cell in an unlicensed band. The base station comprises: controller configured to execute control to transmit a discovery reference signal in the second cell. The controller executes: control to confirm whether or not there is an available channel in the unlicensed band, before transmitting the discovery reference signal; and control to transmit the discovery reference signal in the available channel in the unlicensed band. The discovery reference signal includes a cell-specific reference signal, a primary synchronization signal, a secondary synchronization signal, and a channel-state-information reference signal.

A base station according to a first embodiment is capable of performing communication, in an unlicensed band, with a user terminal capable of performing communication in a licensed band and the unlicensed band. The base station comprises: a controller configured to measure interference power in a predetermined frequency within the unlicensed band; and a transmitter configured to transmit, based on a measurement result of the interference power, a reference signal in the predetermined frequency. The controller stops using the predetermined frequency and considers another frequency within the unlicensed band as a frequency for which the interference power is to be measured, if a transmission count of the reference signal within a predetermined time period is less than a first threshold value.

In the first embodiment, the transmitter transmits data to the user terminal, if the transmission count of the reference signal within a predetermined time period is equal to or more than a second threshold value.

A base station according to a second embodiment and a third embodiment is a base station capable of performing communication, in an unlicensed band, with a user terminal capable of performing communication in a licensed band and the unlicensed band. The base station comprises: a controller configured to measure interference power in a predetermined frequency within the unlicensed band; and a transmitter configured to transmit, based on a measurement result of the interference power, a reference signal in the predetermined frequency. The controller changes a method of transmitting the reference signal, if a transmission count of the reference signal within a predetermined time period is less than a threshold value.

In the second embodiment, the controller increases a measurement count of the interference power within the predetermined time period, if the transmission count of the reference signal within the predetermined time period is less than the threshold value.

In the third embodiment, the controller reduces the transmission power of the reference signal and lengthens a transmission time period of the reference signal than before the method of transmitting the reference signal is changed, if the transmission count of the reference signal within the predetermined time period is less than the threshold value.

A base station according to a forth embodiment is used in a mobile communication system comprising a user terminal capable of performing communication in a licensed band and an unlicensed band. The base station comprises: a controller configured to measure interference power in a predetermined frequency out of a plurality of frequencies available for data transmission and reception in the mobile communication system in the unlicensed band; and a transmitter configured to transmit, based on a measurement result of the interference power, a reference signal. The unlicensed band includes the plurality of frequencies and an unused frequency other than the plurality of frequencies. The transmitter transmits the reference signal in the unused frequency.

A base station according to a fifth embodiment is capable of performing communication, in an unlicensed band, with a user terminal capable of performing communication in a licensed band and the unlicensed band. The unlicensed band includes a plurality of frequency channels. Each of the plurality of frequency channels includes a plurality of frequency resources divided in a frequency direction. The base station includes: a controller configured to measure the interference power in a frequency resource unit; and a transmitter configured to transmit, based on a measurement result of the interference power, a reference signal by using a predetermined frequency resource included in the plurality of frequency resources. The controller notifies the user terminal of resource information indicating the predetermined frequency resource.

A base station according to a sixth embodiment is capable of performing communication, in a licensed band, with a user terminal capable of performing communication in the licensed band and an unlicensed band. The base station comprises: a controller configured to measure interference power in the unlicensed band; and a transmitter configured to transmit, in the unlicensed band, a reference signal. The controller schedules a transmission timing of the reference signal at any timing.

In the sixth embodiment, the controller notifies, in the licensed band, the user terminal of scheduling information indicating a transmission timing of the reference signal.

A communication apparatus according to a seventh embodiment is capable of performing communication in a licensed band and an unlicensed band. The communication apparatus comprises: a controller configured to measure interference power in a predetermined frequency within the unlicensed band; and a transmitter configured to transmit, if interference power of a radio signal in the predetermined frequency based on a measurement result of the interference power is less than a first threshold value, a reference signal in the predetermined frequency. The first threshold value is higher in value than a second threshold value used for determining whether or not it is possible to transmit a data signal different from the reference signal in the predetermined frequency.

In the seventh embodiment, the transmitter transmits the reference signal with transmission power lower than transmission power of the data signal.

In the seventh embodiment, the controller determines, in accordance with interference power in the predetermined frequency, transmission power of the reference signal.

### First Embodiment

Hereinafter, an embodiment in which contents of the present application applies to the LTE system will be described.

(System Configuration)

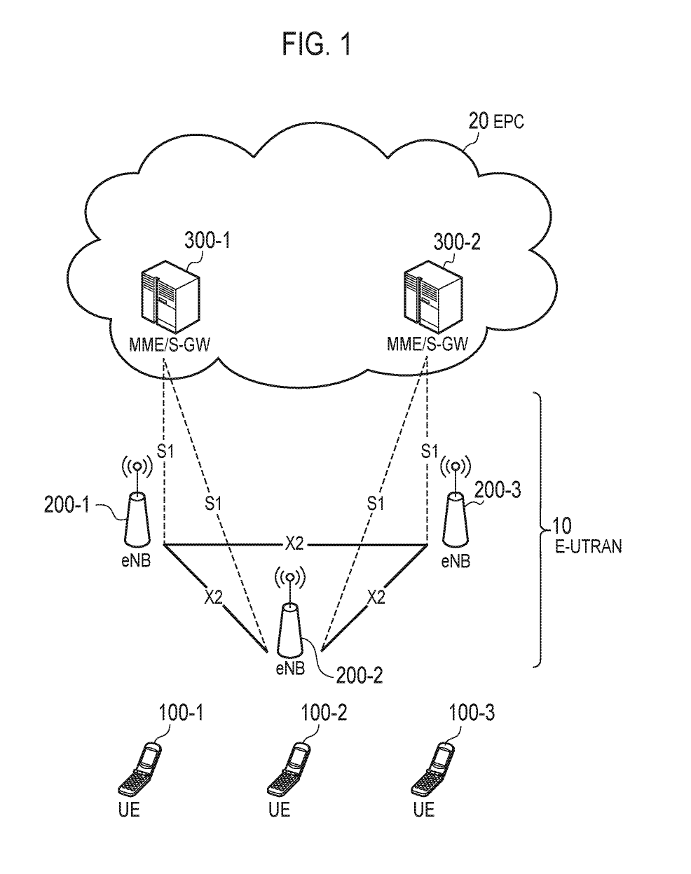

FIG. 1 is a configuration diagram of an LTE system according to the present embodiment. As illustrated in FIG. 1, the LTE system according to the embodiment comprises UEs (User Equipments) 100, E-UTRAN (Evolved Universal Terrestrial Radio Access Network) 10, and EPC (Evolved Packet Core) 20.

The UE 100 corresponds to the user terminal. The UE 100 is a mobile communication apparatus and performs radio communication with a cell (a serving cell) for a connection destination. Configuration of UE 100 will be described later.

The E-UTRAN 10 corresponds to a radio access network. The E-UTRAN 10 includes a plurality of eNBs 200 (evolved Node-Bs). The eNB 200 corresponds to a base station. The eNBs 200 are connected mutually via an X2 interface. Configuration of eNB 200 will be described later.

The eNB 200 manages one cell or a plurality of cells and performs radio communication with the UE 100 that establishes a connection with the cell. The eNB 200 has a radio resource management (RRM) function, a routing function of user data, and a measurement control function for mobility control and scheduling and the like. The “cell” is used as a term indicating a minimum unit of a radio communication area, and is also used as a term indicating a function of performing radio communication with the UE 100.

The EPC 20 corresponds to a core network. The E-UTRAN 10 and the EPC 20 constitute a network of the LTE system (LTE network). The EPC 20 includes MMEs (Mobility Management Entities)/S-GWs (Serving-Gateways) 300. The EPC 20 may include an OAM (Operation and Maintenance).

The MME performs various mobility controls and the like, for the UE 100. The S-GW performs transfer control of user data. The eNB 200 is connected to the MME/S-GW 300 via an S1 interface.

The OAM is a server device managed by an operator and performs maintenance and monitoring of the E-UTRAN 10.

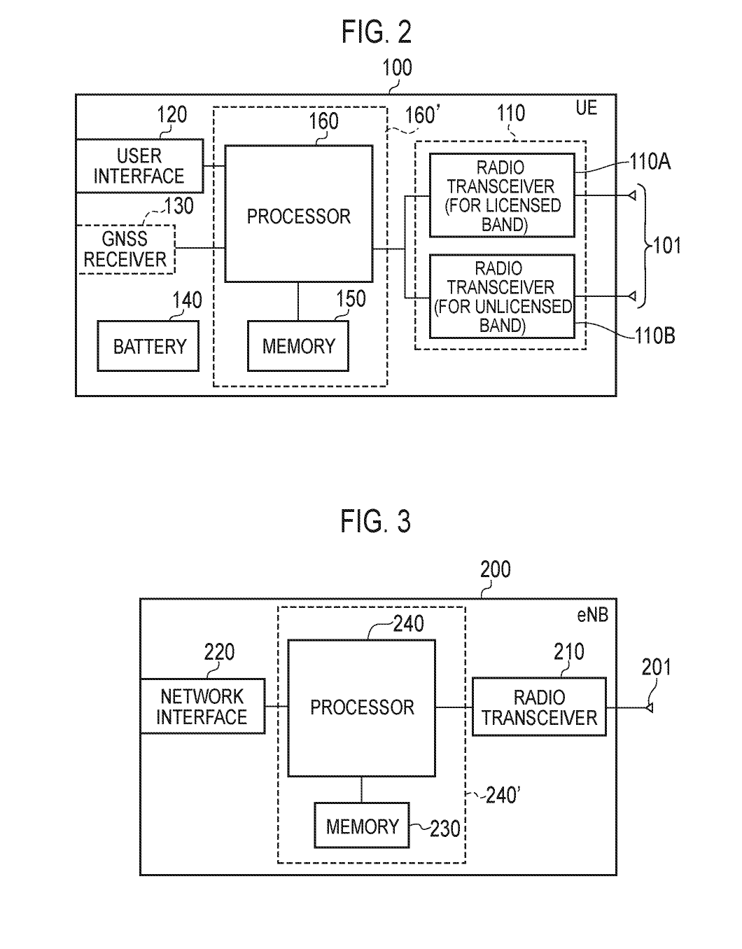

FIG. 2 is a block diagram of the UE 100. As illustrated in FIG. 2, the UE 100 comprises a plurality of antennas 101, a radio transceiver 110, a user interface 120, a GNSS (Global Navigation Satellite System) receiver 130, a battery 140, a memory 150, and a processor 160. The UE 100 may not have the GNSS receiver 130. Furthermore, the memory 150 may be integrally formed with the processor 160, and this set (that is, a chipset) may be called a processor 160′ constituting a controller.

The antennas 101 and the radio transceiver 110 are used to transmit and receive a radio signal. The radio transceiver 110 converts a baseband signal (transmitted signal) output from the processor 160 into the radio signal, and transmits the radio signal from the antennas 101. Furthermore, the radio transceiver 110 converts the radio signal received by the antennas 101 into the baseband signal (received signal), and outputs the baseband signal to the processor 160.

The radio transceiver 110 comprises a radio transceiver 110A and a radio transceiver 110B. The radio transceiver 110A transmits and receives radio signals in the licensed band, and the radio transceiver 110A transmits and receives radio signals in the unlicensed band.

The user interface 120 is an interface with a user carrying the UE 100, and includes, for example, a display, a microphone, a speaker, various buttons and the like. The user interface 120 receives an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for a process by the processor 160. The processor 160 includes a baseband processor that performs modulation and demodulation, encoding and decoding and the like of the baseband signal, and a CPU (Central Processing Unit) that performs various processes by executing the program stored in the memory 150. The processor 160 may further include a codec that performs encoding and decoding of sound and video signals. The processor 160 corresponds to a controller and implements various processes and various communication protocols described later.

FIG. 3 is a block diagram of the eNB 200. As illustrated in FIG. 3, the eNB 200 comprises a plurality of antennas 201, a radio transceiver 210, a network interface 220, a memory 230, and a processor 240. It is noted that the memory 230 may be integrally formed with the processor 240, and this set (that is, a chipset) may be called a processor 240′ constituting a controller.

The antenna 201 and the radio transceiver 210 are used to transmit and receive a radio signal. The radio transceiver 210 transmits and receives radio signals in the licensed band. Alternatively, the radio transceiver 210 may transmit and receive radio signals in the unlicensed band as well as the licensed band. The radio transceiver 210 converts the baseband signal (transmitted signal) output from the processor 240 into the radio signal, and transmits the radio signal from the antenna 201. Furthermore, the radio transceiver 210 converts the radio signal received by the antenna 201 into the baseband signal (received signal), and outputs the baseband signal to the processor 240.

The network interface 220 is connected to the neighboring eNB 200 via the X2 interface and is connected to the MME/S-GW 300 via the S1 interface. The network interface 220 is used in communication performed on the X2 interface and communication performed on the S1 interface.

The memory 230 stores a program to be executed by the processor 240 and information to be used for a process by the processor 240. The processor 240 includes the baseband processor that performs modulation and demodulation, encoding and decoding and the like of the baseband signal and a CPU that performs various processes by executing the program stored in the memory 230. The processor 240 corresponds to a controller and implements various processes and various communication protocols described later.

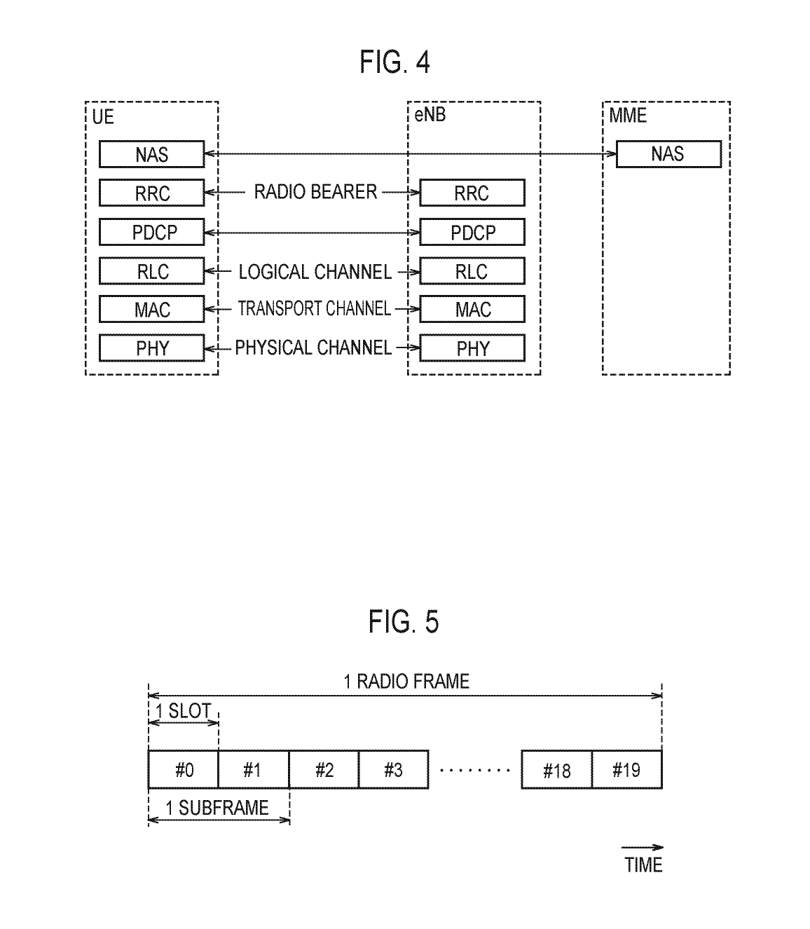

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, user data and control signal are transmitted through the physical channel.

The MAC layer performs preferential control of data, and a retransmission process and the like by hybrid ARQ (HARQ). Between the MAC layer of the UE 100 and the MAC layer of the eNB 200, user data and control signal are transmitted via a transport channel. The MAC layer of the eNB 200 includes a scheduler for determining (scheduling) a transport format of an uplink and a downlink (a transport block size, a modulation and coding scheme) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane which treats the control signal. Between the RRC layer of the UE 100 and the RRC layer of the eNB 200, a control signal (an RRC message) for various types of configurations is transmitted. The RRC layer controls the logical channel, the transport channel, and the physical channel in response to establishment, re-establishment, and release of a radio bearer. When a connection (an RRC connection) is established between the RRC of the UE 100 and the RRC of the eNB 200, the UE 100 is in an RRC connected state, and when the RRC connection is not established, the UE 100 is in an RRC idle state.

A NAS (Non-Access Stratum) layer positioned above the RRC layer performs session management and mobility management, for example.

FIG. 5 is a configuration diagram of a radio frame used in the LTE system. In the LTE system, OFDMA (Orthogonal Frequency Division Multiple Access) is applied in a downlink (DL), and SC-FDMA (Single Carrier Frequency Division Multiple Access) is applied in an uplink (UL), respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. Each resource block includes a plurality of subcarriers in the frequency direction. A radio resource element is configured by one subcarrier and one symbol. Among radio resources assigned to the UE 100, a frequency resource can be configured by a resource block and a time resource can be configured by a subframe (or slot).

(Communication by Utilizing Unlicensed Band)

Communication in which the unlicensed band is utilized according to the present embodiment will be described, below.

The UE 100 is capable of performing communication not only by using a licensed band (licensed spectrum) in which a cellular network operator is granted with a license but also an unlicensed band (unlicensed spectrum) available without a license.

Specifically, firstly, the UE 100 is capable of performing communication by utilizing the unlicensed band by carrier aggregation (CA).

In the CA, in order to realize an enhanced broadband while ensuring a backward compatibility with LTE, a carrier (a frequency band) in the LTE is regarded as a component carrier, and the UE 100 performs communication by simultaneously using a plurality of component carriers (a plurality of serving cells). In the CA, a cell providing predetermined information when a UE starts an RRC connection is referred to as a primary cell (PCell). For example, the primary cell provides NAS mobility information (for example, TAI) at the time of RRC connection establishment/re-establishment/handover and provides security information at the time of the RRC connection re-establishment/handover. On the other hand, a supplementary serving cell forming a pair with the primary cell is referred to as a secondary cell (SCell). The secondary cell is formed together with the primary cell.

If the CA is utilized in communication in which the unlicensed band is utilized, then there may be a case where a predetermined frequency (carrier) in the unlicensed band is utilized as a secondary cell. Hereinafter, if the predetermined frequency is utilized as a secondary cell, the secondary cell is referred to as a U-SCell.

Secondly, the UE 100 is capable of performing communication by utilizing the unlicensed band by a dual connectivity (DC).

In the DC, the UE 100 is allocated with a radio resource from a plurality of eNBs 200. The DC may be referred to as an inter-eNB carrier aggregation (inter-eNB CA).

In the DC, out of a plurality of eNBs 200 establishing connection with the UE 100, only a master eNB (MeNB) establishes the RRC connection with the UE 100. On the other hand, out of the plurality of eNBs 200, a secondary eNB (SeNB) provides an additional radio resource to the UE 100 without establishing the RRC connection with the UE 100. An Xn interface is set between the MeNB and the SeNB. The Xn interface is either an X2 interface or a new interface.

In the DC, the UE 100 is capable of performing the carrier aggregation in which N cells managed by the MeNB and M cells managed by the SeNB are simultaneously utilized. Further, a group including the N cells managed by the MeNB is referred to as a master cell group (MCG). Moreover, a group including the M cells managed by the SeNB is called a secondary cell group (SCG). Further, out of the cells managed by the SeNB, a cell having a function of receiving at least an uplink control signal (PUCCH) is referred to as a PSCell. The PSCell, which has several functions similar to those of the PCell, does not perform an RRC connection with the UE 100 and does not transmit an RRC message, either, for example. It is noted that if the predetermined frequency (carrier) in the unlicensed band is utilized as the Scell, the Scell is referred to as a U-SCell, and if the predetermined frequency is utilized as the PSCell, the Scell is referred to as a U-PSCell.

Here, it is assumed that as a mode of communication in which the unlicensed band is utilized, Licensed-Assisted Access (LAA) is utilized. In the LAA, the UE 100 communicates with a cell operated in the licensed band (hereinafter, a licensed cell) and a cell operated in the unlicensed band (hereinafter, an unlicensed cell). The licensed cell may be used as a PCell and the unlicensed cell may be used as an SCell (or PSCell). If the UE 100 performs communication with a licensed cell and an unlicensed cell, the licensed cell and the unlicensed cell may be managed by one node (for example, the eNB 200). It is noted that if the licensed cell and the unlicensed cell are managed (controlled) by one eNB 200, the unlicensed cell (and the licensed cell) may be formed by a Remote Radio Head (RRH) having a radio transceiver. Alternatively, the licensed cell may be managed by the eNB 200 and the unlicensed cell may be managed by a radio communication apparatus different from the eNB 200. The eNB 200 and the radio communication apparatus may exchange various information described later via a predetermined interface (an X2 interface or an S1 interface). The eNB 200 managing the licensed cell may notify the radio communication apparatus of information obtained from the UE 100 and may notify the UE 100 of information obtained from the radio communication apparatus.

In the unlicensed band, in order to avoid interference with a system (wireless LAN and the like) different from an LTE system or an LTE system of another operator, it is required to execute a clear channel assessment (CCA) (so called Listen Befor Talk (LBT)) before a radio signal is transmitted. Specifically, in the CCA, in order to confirm whether or not the frequency (carrier) in the unlicensed band is available, the eNB 200 measures interference power. The eNB 200 allocates, based on a measurement result of the interference power, a radio resource included in the frequency (carrier) confirmed to have an available channel, to the UE 100 (scheduling). The eNB 200 performs scheduling in the unlicensed cell via the unlicensed cell. Alternatively, the eNB 200 may perform scheduling in the unlicensed cell via the licensed cell (that is, cross-carrier scheduling).

Here, a case is assumed that after measuring interference power, the eNB 200 transmits a reference signal at a frequency in an unlicensed band. The UE 100 may perform measurement for a reference signal transmitted from the eNB 200 and the eNB 200 may report the measurement result to a management. The eNB 200 is capable of determining, based on the measurement result, the availability or unavailability of communication with the UE 100 in the unlicensed band or a communication quality in the unlicensed band.

However, if a condition continues where the measurement result of the interference power is poor (that is, if the interference power continues to be high), the eNB 200 is not capable of transmitting the reference signal for a long period of time. As a result, a problem arises that it is not possible to effectively utilize the unlicensed band.

Accordingly, the problem described above is resolved by a method described below.

Below, it is assumed that an operation by the eNB 200 is an operation by a cell managed by the eNB 200, which will be discussed where appropriate. Further, it should be noted that while a case where one eNB 200 performs communication with the UE 100 at a frequency in the licensed band (licensed cell) and at a frequency in the unlicensed band (unlicensed cell) will be mainly described below; this is not limiting.

(Operation According to First Embodiment)

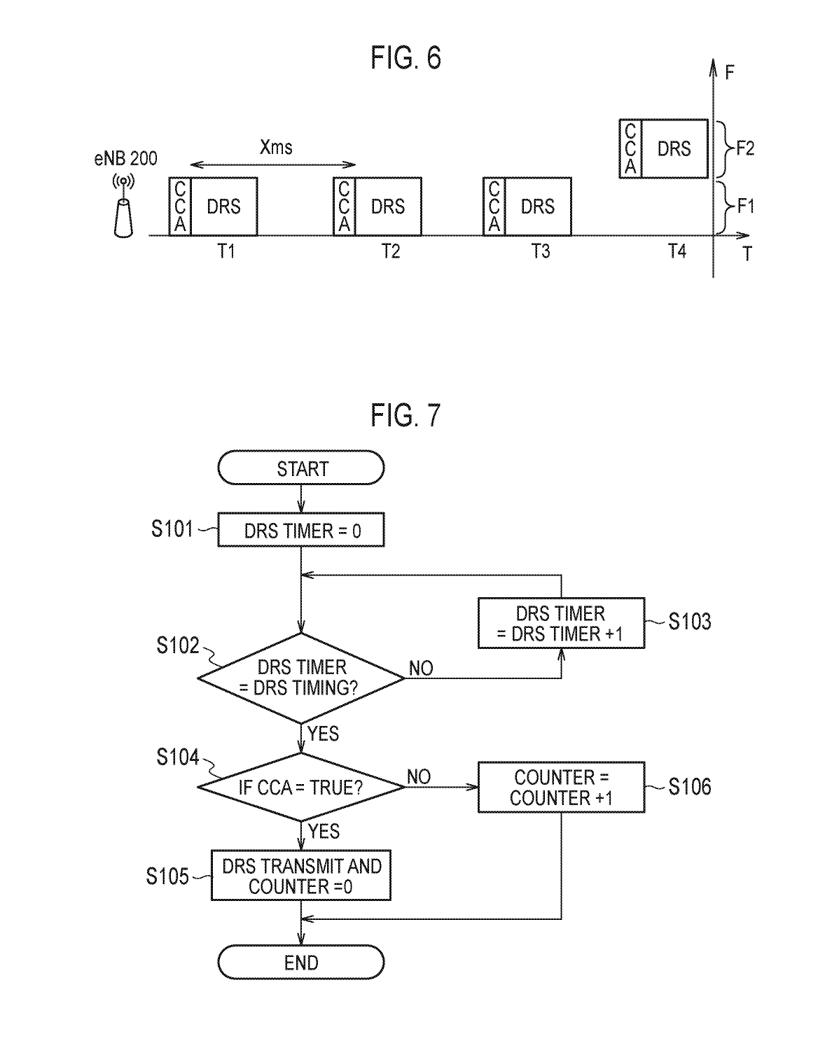

Next, an operation according to a first embodiment will be described with reference to FIG. 6. FIG. 6 is a diagram for describing an operation according to the first embodiment.

The eNB 200 is set to periodically (for example, at intervals of Xms) transmit a radio signal. However, if interference power exceeds a threshold value (if interference is detected) as a result of measuring the interference power in a predetermined frequency in the unlicensed band, the eNB 200 cancels the transmission of the radio signal.

As illustrated in FIG. 6, at t1, the eNB 200 measures interference power at a frequency f1 in the unlicensed band. The eNB 200 transmits a reference signal, based on the measurement result. The interference power is less than a threshold value, and thus, the eNB 200 transmits the reference signal at the frequency f1.

Here, the reference signal is a discovery reference signal (DRS), for example. The DRS includes a signal of at least any one of a synchronization signal (primary synchronization signal (PSS) and/or a secondary synchronization signal (SSS)), a cell reference signal, a channel state information reference signal (CSI-RS), and a demodulation reference signal (DL-DMRS) in the downlink. Therefore, the DRS is utilized for at least any one of identification of a cell, synchronization, or observation of the channel state.

At t2, the eNB 200 measures, similarly to t1, interference power at the frequency f1 in the unlicensed band, and transmits a reference signal, based on the measurement result.

At t3, the eNB 200 measures, similarly to t1, interference power at the frequency f1 in the unlicensed band. The interference power is equal to or more than a threshold value, and thus, the eNB 200 cancels the transmission of the reference signal.

Here, if a transmission count of a reference signal within a predetermined time period is less than a first threshold value, the eNB 200 cancels the use of the frequency f1 and considers another frequency in the unlicensed band as a frequency to measure interference power. In the embodiment, the eNB 200 determines that the transmission count is equal to or more than the first threshold value and considers the frequency f2 as a frequency to measure interference power.

At t4, the eNB 200 measures, similarly to t1, interference power at the frequency f2 in the unlicensed band, and transmits a reference signal, based on the measurement result. The interference power is less than a threshold value, and thus, the eNB 200 transmits the reference signal at the frequency f2.

As a result, the eNB 200 is capable of continuously transmitting a reference signal at a frequency at which no interference is detected. On the other hand, the eNB 200 does not continue measurement of interference power at a frequency at which interference is highly likely to be detected. As a result, it is possible to prevent unavailability where a reference signal cannot be transmitted in the unlicensed band for a long period of time.

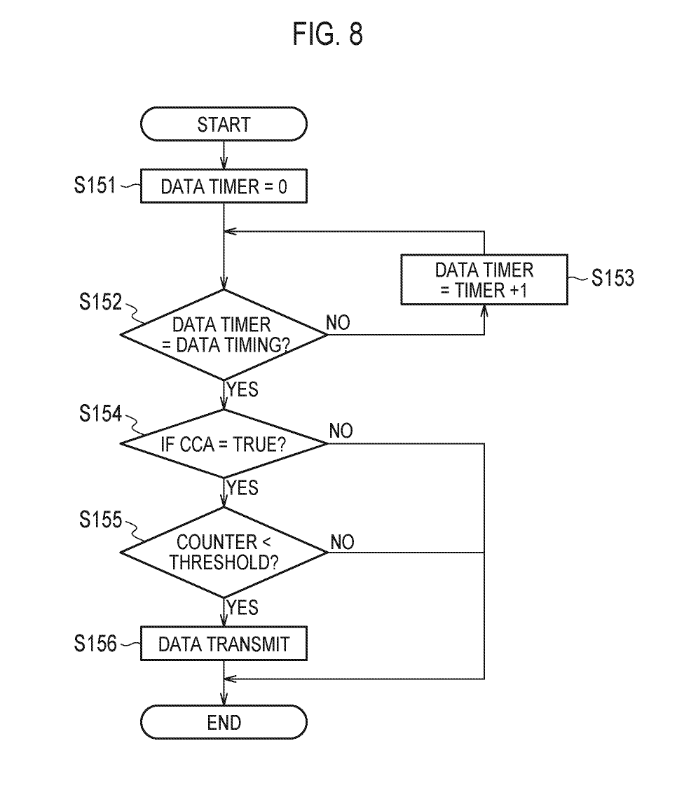

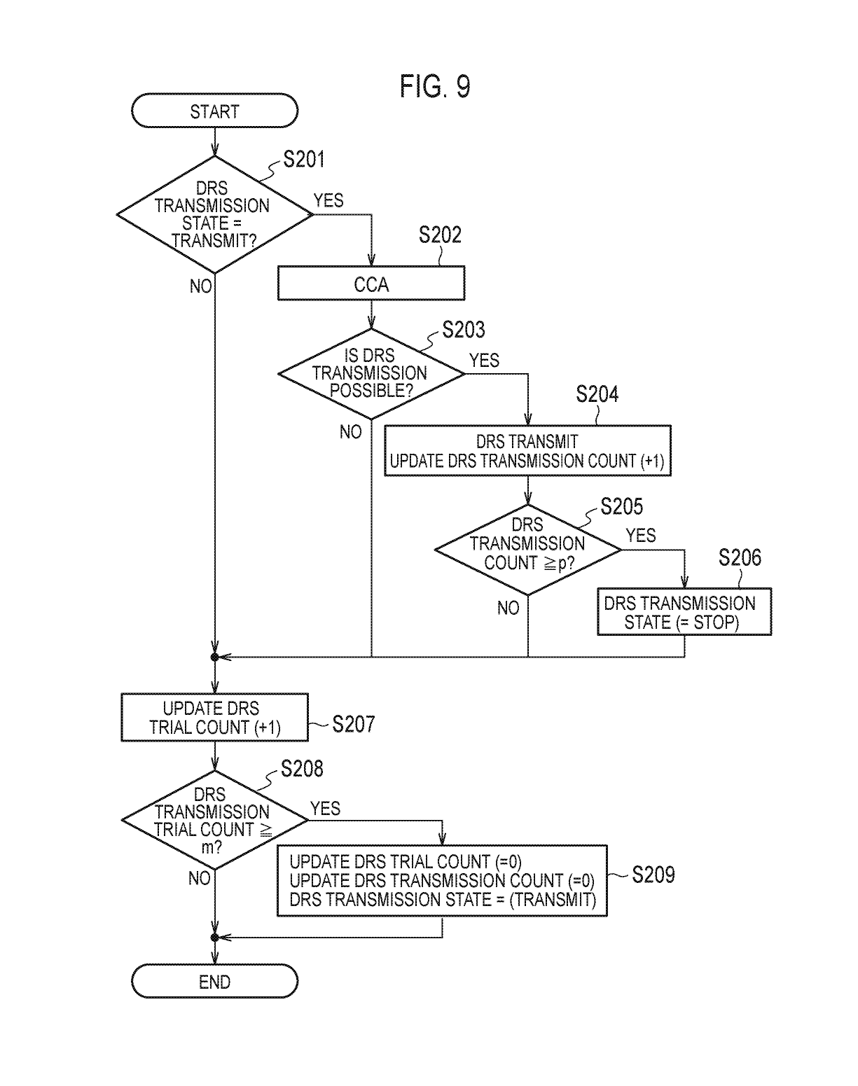

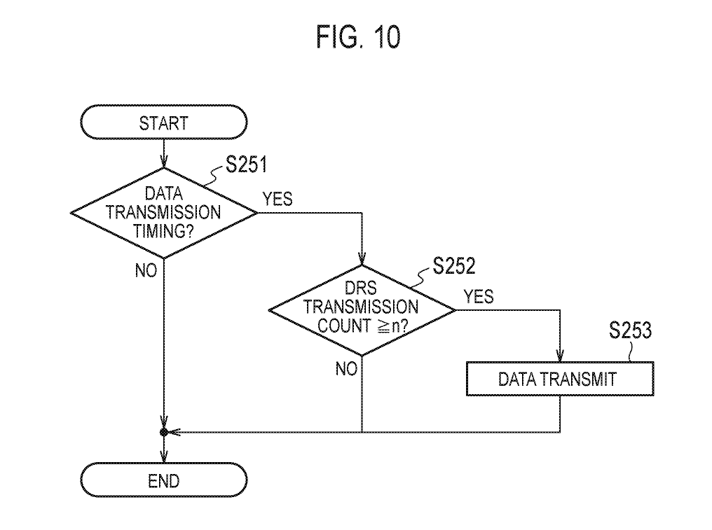

Next, an operation example of the eNB 200 according to the first embodiment will be described with reference to FIG. 7 to FIG. 10. FIG. 7 and FIG. 8 are diagrams for describing an operation example 1 of the eNB 200 according to the first embodiment. FIG. 9 and FIG. 10 are diagrams for describing an operation example 2 of the eNB 200 according to the first embodiment.

### (A) Operation Example 1

First, a method of changing a frequency (carrier) to be measured will be described with reference to FIG. 7.

As illustrated in FIG. 7, in step S101, the eNB 200 sets a DRS timer to zero.

In step S102, the eNB 200 determines whether or not a value of the DRS timer is equal to a DRS transmission timing. The DRS transmission timing is set to X [ms], for example. If the value of the DRS timer is not equal to the DRS transmission timing (N), a process of step S103 is executed. If the value of the DRS timer is not equal to the DRS transmission timing (Y), a process of step S104 is executed.

In step S103, the eNB 200 increases by one the value of the DRS timer. Next, the eNB 200 executes a process of step S102.

In step S104, the eNB 200 determines whether or not interference power in a predetermined frequency is less than a threshold value. If the interference power is less than the threshold value (Y), a process of step S105 is executed. On the other hand, if the interference power is equal to or more than the threshold value (N), a process of step S106 is executed.

In step S105, the eNB 200 transmits a reference signal at the predetermined frequency. In addition, the eNB 200 sets to zero a non-transmission counter indicating the number of times that a reference signal (DRS) has not been transmitted.

In step S106, the eNB 200 increases by one the number of the non-transmission counter.

Here, if the non-transmission counter exceeds the threshold value, (that is, if the transmission count of the reference signal is less than the threshold value), the eNB 200 stops using the predetermined frequency for which current interference power is to be measured. The eNB 200 considers another frequency in the unlicensed band as a frequency to be measured.

Next, a method of determining whether or not the eNB 200 transmits data to the UE 100 will be described with reference to FIG. 8.

As illustrated in FIG. 8, in step S151, the eNB 200 sets a value of a data timer to zero.

In step S152, the eNB 200 determines whether or not a value of the data timer is equal to a data transmission timing. The data transmission timing is set to Y [ms], for example. If the value of the data timer is not equal to the data transmission timing (N), a process of step S153 is executed. On the other hand, if the value of the data timer equals to the data transmission timing (Y), a process of step S154 is executed.

In step S153, the eNB 200 increases by one the value of the data timer. Next, the eNB 200 executes a process of step S152.

In step S154, the eNB 200 determines whether or not interference power in a predetermined frequency is less than a threshold value. If the interference power is less than the threshold value (Y), a process of step S155 is executed. On the other hand, if the interference power is equal to or more than the threshold value (N), the eNB 200 ends the process.

In step S155, the eNB 200 determines whether or not a non-transmission counter indicating the number of times that a reference signal (DRS) has not been transmitted is less than a threshold value. If the non-transmission counter is less than the threshold value (Y), a process of step S156 is executed. On the other hand, if the non-transmission counter is equal to or more than the threshold value (N), the eNB 200 ends the process.

Due to the UE 100 not being capable of receiving a reference signal for a certain period because the transmission count of a reference signal is too small, synchronization between the eNB 200 and the UE 100 may not be established. Therefore, by transmitting data only if the transmission count of the reference signal is large (if the transmission count of the reference signal exceeds the threshold value) in a predetermined time period, the eNB 200 may omit transmission of unnecessary data that the UE 100 is not capable of receiving.

### (B) Operation Example 2

First, a method of changing a frequency (carrier) to be measured will be described with reference to FIG. 9.

As illustrated in FIG. 9, in step S201, the eNB 200 determines whether or not a DRS transmission state is “transmit”. If the DRS transmission state is “transmit” (“Yes”), a process of step S202 is executed. On the other hand, if the DRS transmission state is not “transmit” (“No”), a process of step S207 is executed.

In step S202, the eNB 200 measures interference power in a predetermined frequency.

In step S203, the eNB 200 determines, based on a measurement result of the interference power, whether or not the eNB 200 can transmit a DRS. If the eNB 200 can transmit a DRS (Yes), a process of step S204 is executed. On the other hand, if the eNB 200 cannot transmit a DRS (No), a process of step S207 is executed.

In step S204, the eNB 200 transmits a DRS at a predetermined frequency. The eNB 200 increases by one the transmission count of the DRS to update the DRS transmission count.

In step S205, the eNB 200 determines whether or not the DRS transmission count is equal to or more than a threshold value (p). If the DRS transmission count is equal to or more than the threshold value, a process of step S206 is executed. If the DRS transmission count is less than the threshold value, a process of step S207 is executed.

If the DRS transmission count reaches the threshold value (p) within a predetermined time period, a trial of DRS transmission is stopped at a predetermined time. As a result, it is possible to prevent an unnecessary transmission of a DRS. It is noted that a timing of a trial of DRS transmission in the predetermined time period follows a certain rule.

In step S206, the eNB 200 changes the DRS transmission state to “stop”.

In step S207, the eNB 200 increases by one a DRS trial count so as to update the DRS trial count.

In step S208, the eNB 200 determines whether or not the DRS trial count is equal to or more than a threshold value (m). If the DRS trial count is equal to or more than the threshold value (Yes), a process of step S209 is executed. If the DRS trial count is less than the threshold value (No), the eNB 200 ends the process.

In step S209, the eNB 200 sets the DRS trial count to zero so as to update the DRS trial count. Further, the eNB 200 sets the DRS transmission count to zero so as to update the DRS transmission count. Furthermore, the eNB 200 changes the DRS transmission state to “transmit”.

It is noted that the threshold value (m) is the number of times that the DRS transmission is tried within a predetermined time period. The threshold value (m) is a value larger than a threshold value (n) described below.

Next, a method of determining whether or not the eNB 200 transmits data to the UE 100 will be described with reference to FIG. 10.

As illustrated in FIG. 10, in step S251, the eNB 200 determines whether or not a data transmission timing has arrived. If the data transmission timing has arrived, a process of step S252 is executed. On the other hand, if the data transmission timing has not arrived, the eNB 200 ends the process.

In step S252, the eNB 200 determines whether or not the DRS transmission count is equal to or more than the threshold value (n). If the DRS transmission count is equal to or more than the threshold value, a process of step S253 is executed. On the other hand, if the DRS transmission count is less than the threshold value, the eNB 200 ends the process.

In step S253, the eNB 200 transmits data. It is noted that the data transmission is performed if the interference power is less than the threshold value.

Thus, if the transmission count of a reference signal is large (if the transmission count of a reference signal exceeds a threshold value) within a predetermined time period, the eNB 200 is capable of transmitting data. In addition, if the transmission count of a reference signal is equal to or more than the threshold value (p), the eNB 200 stops transmission of a reference signal (step S205, S206). As a result, it is possible to increase an opportunity allowing another radio communication apparatus to transmit data by preventing unnecessary transmission of a reference signal.

### Second Embodiment

Next, a second embodiment will be described. Description of similar portions to the above-described embodiments will be omitted where appropriate.

In the second embodiment, if the transmission count of a reference signal within a predetermined time period is less than a threshold value, a method of transmitting a reference signal is changed. Specifically, a measurement count (the CAA count) of interference power is increased.

For example, it is assumed that the eNB 200 is set to transmit a reference signal at intervals of Xms. If the eNB 200 cannot often transmit a reference signal on the basis of the measurement result of interference power, the transmission count of a reference signal within a predetermined time period reaches short of the threshold value. In this case, the eNB 200 increases the measurement count of interference power within the predetermined time period. That is, the eNB 200 increases the number of times to measure the interference power. This increases the opportunity for measuring interference power, and thus, the eNB 200 may have more measurement results with less than the threshold value of the interference power. As a result, the number of times that a reference signal can be transmitted increases, and thus, it may be possible to prevent unavailability where a reference signal cannot be transmitted in the unlicensed band for a long period of time.

It is noted that if the number of times to measure interference power is increased, the eNB 200 may randomly set a measurement timing of interference power. Consequently, if another radio communication apparatus periodically transmits a radio signal, the eNB 200 will have more measurement results with less than the threshold value of the interference power. As a result, the number of times that a reference signal is transmitted increases, and thus, it is possible to prevent unavailability where a reference signal cannot be transmitted for a long period of time.

### Third Embodiment

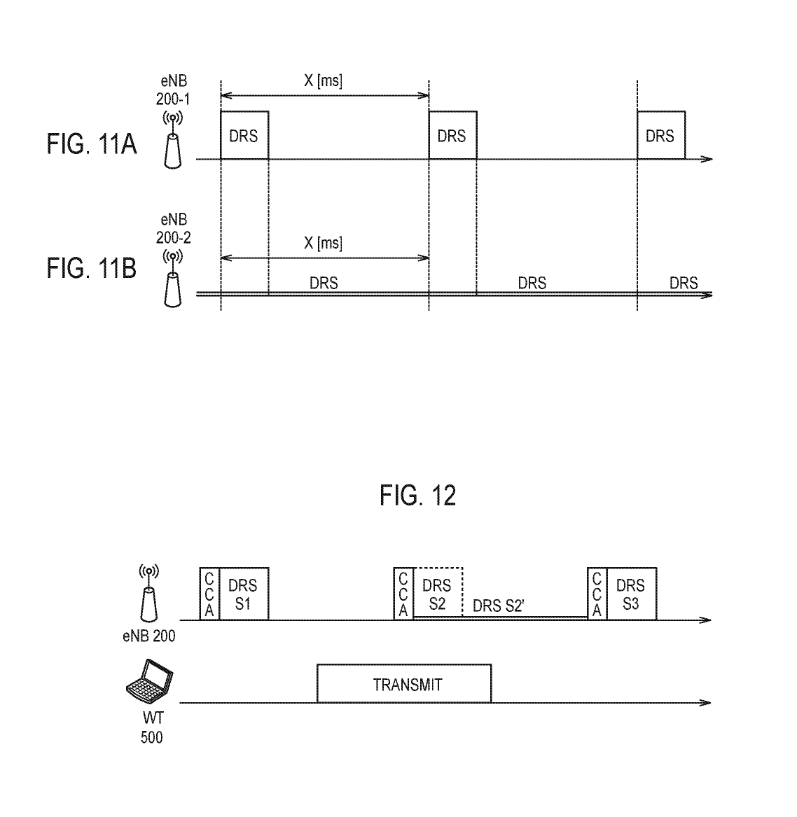

Next, a third embodiment will be described with reference to FIGS. 11A, 11B and FIG. 12. FIGS. 11A, 11B and FIG. 12 are diagrams for describing an operation according to the third embodiment. Description of similar portions to each of the above-described embodiments will be omitted where appropriate.

In the third embodiment, if the transmission count of a reference signal within a predetermined time period is less than a threshold value, transmission power and a transmission time period of the reference signal are changed.

As illustrated in FIG. 11A, before changing a method of transmitting a reference signal, the eNB 200 is set to transmit a reference signal periodically (at intervals of X [ms]).

On the other hand, as illustrated in FIG. 11B, if the method of transmitting a reference signal is changed, the eNB 200 reduces transmission power of the reference signal and lengthens the transmission time period of the reference signal compared with before changing the transmission method of the reference signal. For example, during X [ms], the eNB 200 spreads and transmits the reference signal at low power. For example, a value of the transmission power of the reference signal is so small that the transmission power obtained by adding up power used to transmit the spread reference signals is ordinary transmission power of a reference signal. Alternatively, the value of the transmission power of the reference signal is so small that another radio communication apparatus cannot detect the interference on the basis of the reference signal (value less than a threshold value by which the interference power is determined).

As illustrated in FIG. 12, if detecting interference by a radio signal from a WT 500, the eNB 200 spreads and transmits a reference signal. If the interference is not detected, the eNB 200 may transmit a regular reference signal. Alternatively, the eNB 200 may spread and transmit the reference signal for a predetermined period from the time of detecting the interference (for example, a period of n times the X [ms]).

As a result, even if interference is detected, it is possible to transmit a reference signal, and thus, it is possible to prevent unavailability where a reference signal cannot be transmitted for a long period of time.

### Fourth Embodiment

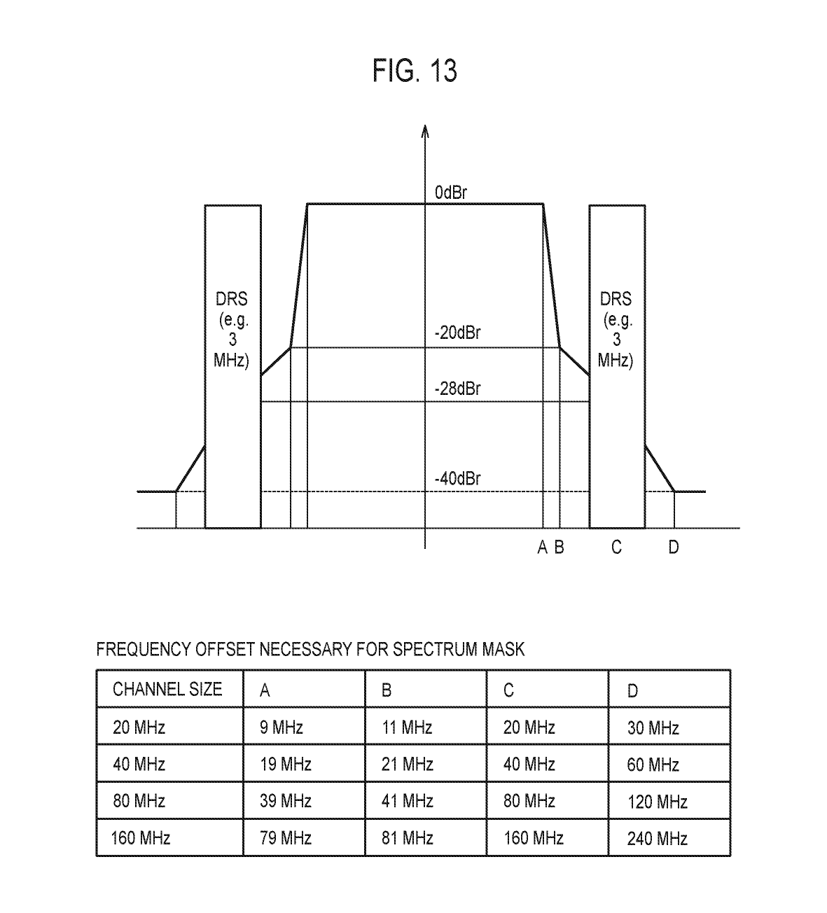

Next, a fourth embodiment will be described with reference to FIG. 13 to FIG. 15. FIG. 13 to FIG. 15 are diagrams illustrating one example of a transmission frequency of a reference signal according to the fourth embodiment. Description of similar portions to each of the above-described embodiments will be omitted where appropriate.

In the fourth embodiment, the eNB 200 transmits, in the unlicensed band, a reference signal at an unused frequency other than a plurality of frequencies available for transmitting and receiving data in the mobile communication system. For example, in the unlicensed band, a DRS region for transmitting a reference signal may be provided at a frequency (region) different from a plurality of frequencies used as a channel (carrier). For example, all the eNBs 200 (LAAeNBs 200) transmit a reference signal in the DRS region. In the DRS region, it is possible to transmit reference signals regardless of detection of interference.

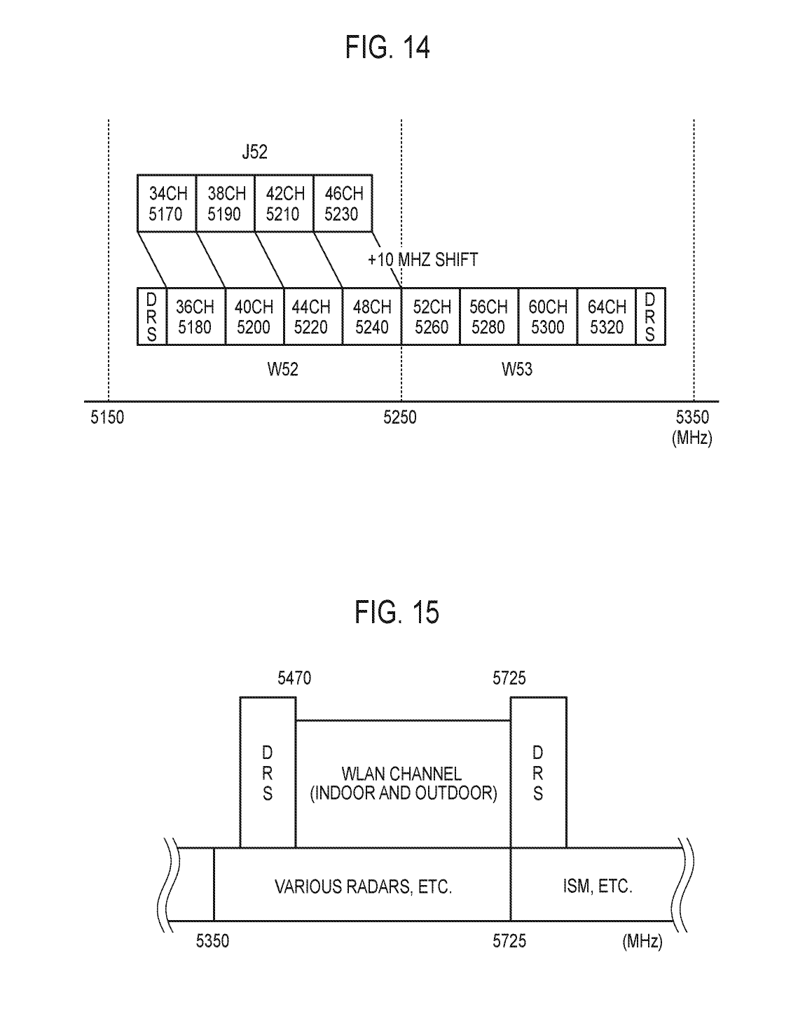

As illustrated in FIG. 14, the DRS region may be provided in a guard band located between channels. For example, the eNB 200 transmits a reference signal in a frequency (DRS region) in a 20-MHz band, that is, a channel in the unlicensed band. The DRS region may be provided at a width of 3 MHz on both sides of the 20-MHz band or at a width of 6 MHz on one side of the 20-MHz band.

Further, as illustrated in FIG. 15, the DRS region may be provided in a frequency (channel) outside, in a frequency direction, of a channel (20-MHz band) group in the unlicensed band.

Furthermore, as illustrated in FIG. 15, the DRS region may be provided in a frequency (channel) outside, in the frequency direction, of a WLAN channel.

As a result, the eNB 200 is capable of transmitting a reference signal in the DRS region, and thus, it is possible to prevent unavailability where the reference signal cannot be transmitted for a long period of time.

### Fifth Embodiment

Next, a fifth embodiment will be described. Description of similar portions to each of the above-described embodiments will be omitted where appropriate.

In the fifth embodiment, each of a plurality of channels (frequencies) in the unlicensed band includes a frequency resource divided in a frequency direction. For example, each of the plurality of channels includes a frequency resource divided in an RB (resource block) unit or a unit larger than the RB (for example, in a 1.4-MHz unit).

The eNB 200 detects interference for every frequency resource. The eNB 200 transmits a reference signal by using a predetermined frequency resource in which no interference is detected.

The eNB 200 may notify the UE 100 of resource information indicating a predetermined frequency resource. For example, the resource information indicates a subframe and an available frequency (frequency at which no interference is detected). For example, the resource information may be exchanged by using an Air signal between the eNBs 200 of LTE (between LAA eNBs) in which the unlicensed band is utilized.

This enables each eNB 200 to transmit a reference signal in a frequency resource unit. Therefore, compared to when a reference signal is transmitted in a channel unit, even with the same bandwidth, there will be more locations where a reference signal can be transmitted. As a result, it may be possible to prevent unavailability where a reference signal cannot be transmitted in the unlicensed band for a long period of time.

### Sixth Embodiment

Next, a sixth embodiment will be described. Description of similar portions to each of the above-described embodiments will be omitted where appropriate.

In the sixth embodiment, the eNB 200 dynamically schedules a reference signal in the unlicensed band. Specifically, the eNB 200 schedules a transmission timing of a reference signal at any timing. The eNB 200 measures interference power before a time-frequency resource, in the unlicensed band, allocated to transmission of a reference signal. If the interference power is less than a threshold value, the eNB 200 transmits the reference signal by using the allocated time-frequency resource.

Further, the eNB 200 notifies the UE 100 of scheduling information indicating a time-frequency resource, in the unlicensed band, allocated to transmission of a reference signal. The eNB 200 is capable notifying the UE 100 of the scheduling information, in the licensed band (via a PDCCH/ePDCCH). By utilizing an Air signal between the eNBs 200 of LTE (between LAA eNBs) in which the unlicensed band is utilized, the scheduling information may be exchanged.

As a result, a reference signal is scheduled dynamically, and thus, it is possible to prevent unavailability where a reference signal cannot be transmitted for a long period of time.

### Seventh Embodiment

Next, a seventh embodiment will be described. Description of similar portions to each of the above-described embodiments will be omitted where appropriate.

In the seventh embodiment, a threshold value for detecting interference differs between a case where a reference signal is transmitted in the unlicensed band and a case where a data signal (user data and the like) is transmitted in the unlicensed band.

Specifically, when measuring interference power (CAA) to transmit a reference signal, the eNB 200 compares the interference power (received power) with a first threshold value. On the other hand, when measuring interference power (CAA) to transmit a data signal, the eNB 200 compares the interference power (received power) with a second threshold value. Here, the first threshold value is higher than the second threshold value. Therefore, even if the interference power (RS interference power) measured for transmitting the reference signal and the interference power (data interference power) measured for transmitting the data signal are the same power, the RS interference power may be less than the first threshold value and the data interference power may be equal to or more than the second threshold value. In this case, the eNB 200 is not capable of transmitting the data signal but capable of transmitting the reference signal. Therefore, the transmission count of a reference signal increases, and thus, it is possible to prevent unavailability where a reference signal cannot be transmitted in the unlicensed band for a long period of time.

Further, the eNB 200 may transmit the reference signal with transmission power lower than the transmission power of the data signal. As a result, it is possible to reduce the possibility that the reference signal applies interference.

Further, the eNB 200 may determine the transmission power of the reference signal in accordance with the interference power immediately before transmission of the reference signal (interference power based on the CAA result). Specifically, the eNB 200 may reduce the transmission power of the reference signal when the interference power is large, and may increase the transmission power of the reference signal when the interference power is small. The eNB 200 may store a plurality of threshold values having a different value, and may determine the transmission power of the reference signal according to the threshold value.

Further, the eNB 200 may determine not only the transmission power of the reference signal in accordance with the interference power immediately before transmission of the reference signal but also with the transmission power of the data signal. That is, the eNB 200 may configure that the transmission power of the data signal corresponds to the transmission power of the reference signal determined in accordance with the interference power. In this case, a coverage of the unlicensed cell changes according to the interference power. Therefore, the eNB 200 periodically changes the coverage of the unlicensed cell in accordance with a transmission interval of the reference signal. It is noted that the unlicensed cell functions as a serving cell, only for the UE 100 in which the measurement result of the reference signal (RSRP: reference signal received power) is equal to or more than a threshold value.

This prevents unavailability where a reference signal cannot be transmitted in the unlicensed band for a long period of time.

### Other Embodiments

In each of the above-described embodiments, a case is described where the eNB 200 transmits a reference signal in the unlicensed band; however, this is not limiting. If the UE 100 transmits a reference signal in the unlicensed band, the UE 100 is capable of performing a similar operation to the above-described eNB 200.

Each of the above-described embodiments may be implemented independently and separately; two or more embodiments may be combined and implemented.

In the above-described embodiments, although an LTE system is described as an example of a mobile communication system, it is not limited to the LTE system, and contents of the present application may be applied to a system other than the LTE system.

[Additional Statement]

(1) Introduction

In this additional statement, we present the design of reference signal(s) for the LAA RRM measurement. We also provide our views about the other functionalities with taking our approach to the reference signal(s) into account.

(2) Design of Reference Signal(s) for RRM Measurement

It was agreed Rel-12 DRS is the starting point for the design of reference signal used in RRM measurements on the unlicensed band. Based on Rel-12 DRS design, the eNB is required to transmit PSS/SSS/CRS (and CSI-RS) at fixed intervals without exception. It can be achieved without any problem because the eNB uses the assigned licensed band resources to transmit the DRS. However, in contrast to the licensed band, more than one radio systems/nodes could share the unlicensed band. In addition to sharing the unlicensed band, each system use LBT (listen before talk) to avoid collisions which is required in some countries/regions. Therefore, in our view LBT is required when DRS is transmitted on the unlicensed band.

One design aspect is to consider whether LBT should be a mandatory function or not. LBT is a mandatory function in EU and Japan, but EU regulation allows the transmission of management and controlling frames without sensing the frequency for the presence of a signal i.e., Short Control Signaling Transmission. According to the EU regulation, the Short Control Signalling Transmissions of Adaptive equipment shall have a maximum duty cycle of 10% within an observation period of 50 msec. Based on the above requirement if the DRS transmission satisfies the conditions, the LTE eNB can transmit DRS on the unlicensed band without performing the LBT. However, we believe the LBT should be mandated because it helps to obtain fair coexistence with the other systems and avoid collisions. The LBT mandate could also be viewed as a simple design and provide one universal solution for all the regions where LAA is expected to be deployed.

Proposal 1: Proposal 1: it should agree to apply LBT functionality to the Rel-12 DRS based LAA DRS transmissions.

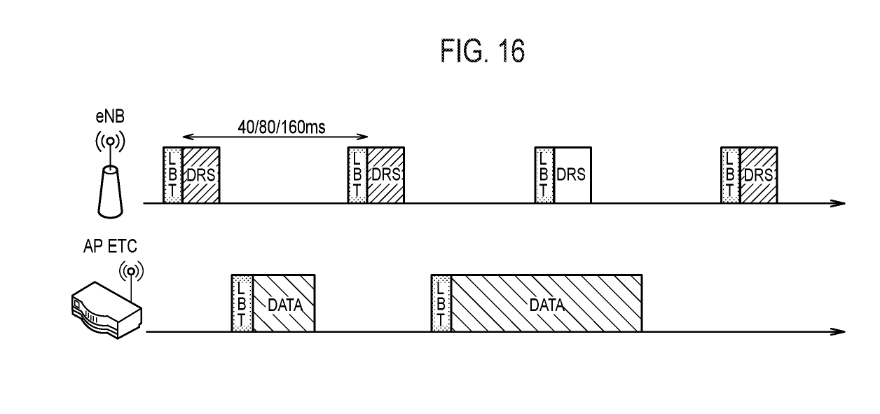

If Proposal 1 is accepted as an agreement, the LBT functionality does not allow the eNB to transmit its DRS on the unlicensed band if a busy channel is detected (See FIG. 16). As a consequence, the measurement accuracy requirement may not be satisfied when the eNB does not transmit DRS during some of the DRS transmission opportunities. According to the current definition of RSRP measurement the UE shall measure RSRP in the subframes configured as discovery signal occasions. It means UE must monitor the configured radio resources and may include those resources' results in the final measurement result regardless of whether DRS were actually transmitted or not in those resources. In addition, the number of resource elements within the considered measurement frequency bandwidth and within the measurement period that are used by the UE to determine RSRP is left up to the UE implementation with the limitation that corresponding measurement accuracy requirements have to be fulfilled. Therefore, there is a possibility that the reported RSRP could be highly inaccurate. The combination of UE implementation based RSRP measurements and unavailability of some of the DRS transmissions due to eNB's LBT functionality results into a problem where the UE is unable to provide an accurate unlicensed band's radio environment information to the eNB.

We believe the above issue must be addressed in RAN4. One approach is RAN1 sends a request LS to RAN4 to perform a study to verify if the current measurement accuracy requirement is satisfied by the existing specification. In case the current specification does not satisfy the accuracy requirement then new solutions can be considered. The following are some of the candidate alternatives.

Alternative 1: eNB Broadcast/Unicast a DRS Measurement Indication on the Licensed Band.

In this alternative, the eNB inform the UE(s) via the licensed band about the conditions under which subframe RSRP should be calculated. During the RSRP calculations, the UE is expected to adopt and modify its DRS measurements in accordance to the information provided by the eNB about the RSRP measurement conditions on the unlicensed band. When and how the eNB can provide this information to the UEs is for further study.

Alternative 2: To Define a CRS (Included in DRS) Based RSRP Measurement for LAA.

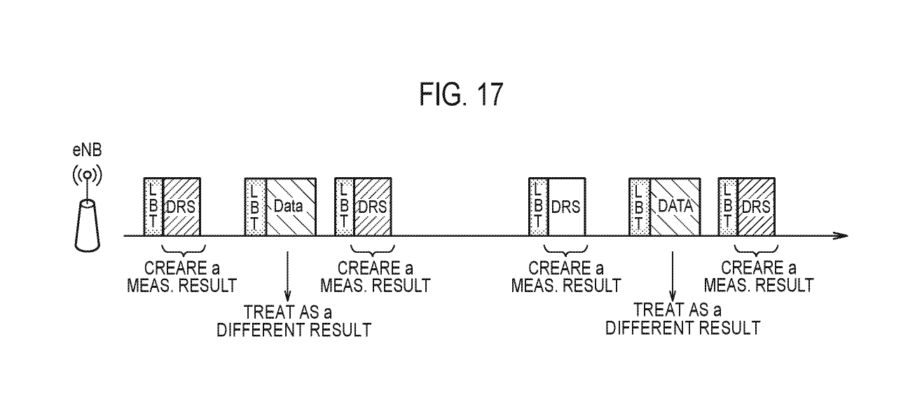

In this alternative, some limitation is applied how a UE performs the DRS measurements to determine RSRP. For example, UE should send one measurement result per one DRS burst. Since eNB is aware which DRS was transmitted on the unlicensed band, the eNB can determine if the received measurement report from a particular UE is reliable or not (See FIG. 17).

Proposal 2: If the proposal 1 is accepted as an agreement, RAN1 should send a LS to RAN4 requesting if the measurement accuracy requirement is satisfied by the existing specification.

(3) Analysis of Functionalities for LAA

Unlike RRM measurement, the reference signals for supporting other functionalities were not addressed. If the proposal 1 is accepted as an agreement, then the Rel-12 DRS with LBT should be the starting point for other functionalities as well. We believe the AGC (Automatic Gain Control) setting, coarse synchronization and the CSI measurements can be performed using the above DRS for LAA. It could be a baseline solution. However, further study is needed for the case when the eNB does not transmit DRS during some of the DRS transmission opportunities. As discussed before this situation is similar to the RRM measurement.

On the other hand, fine frequency/time estimation for at least demodulation may not be achieved if eNB cannot transmit DRS more than the current specified maximum DRS interval. The existing specification is not guaranteed the DRS interval longer than 160 msec. We discuss this issue further in the next section.

Proposal 3: The LAA DRS based on Rel-12 DRS with LBT should also be used for the AGC setting, coarse synchronization and the CSI measurement.

(4) Synchronization Signal Design

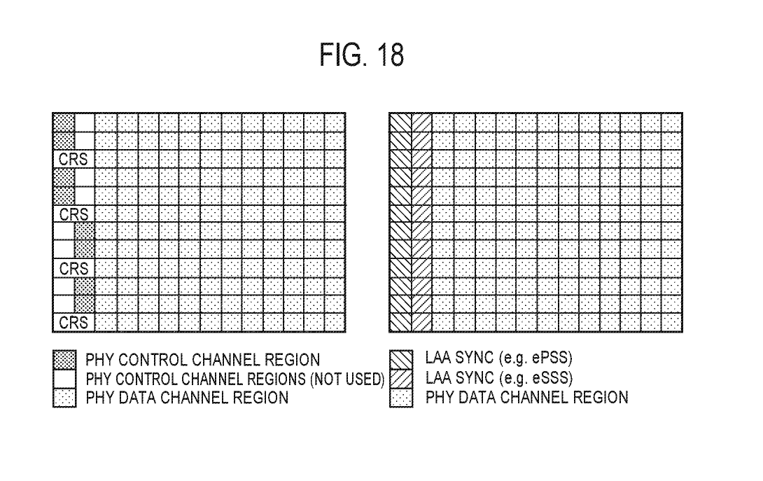

As mentioned before the LBT based transmission is needed in the unlicensed bands in various countries/regions. Therefore, there is a possibility that eNB may not be able to transmit DRS on the unlicensed band for a long period of time due to the presence of other transmissions by the neighboring nodes sharing the same band. One approach is to set a fix maximum limit for the duration between the two DRS transmissions, for example 160 msec. If eNB cannot transmit DRS a longer time than the maximum limit, it should be assumed fine frequency/time estimation is not guaranteed. However, it also possible due to interference a UE was unable to detect/decode some of the DRS transmissions correctly. This situation forces us to consider providing another synchronization signal within the data transmissions in addition to the DRS transmissions. One solution is the eNB transmits the synchronization signals (LAA sync) in the symbols located before the data region (e.g., the first symbols of a subframe) (See FIG. 18). This approach is very similar to the D2D synchronization signal design. In that case, the UE achieves a coarse synchronization using the DRS and achieve finer frequency/time estimation using the above LAA sync. If this solution is applied, AGC setting is performed based on the LAA sync instead of the DRS as the LAA sync is located next to the data region within the first subframe received at the UE.

We propose the current Physical control channel regions should be replaced by LAA sync. The number of resource elements used to transmit Physical control channels is changed according to e.g., the number of UEs scheduled in the subframe. In case of low-traffic conditions it is possible Physical control channel regions is not fully occupied resulting in low resource element density and consequent low transmit power over the OFDM symbol resulting in higher miss-detection by the neighboring nodes. This results in the collisions as the neighboring nodes may assume the channel is available for their respective transmissions. To avoid the collisions, we propose Physical control channels should be removed from the unlicensed band transmissions and LAA sync should be transmitted as a replacement. Further study is needed how LAA sync is mapped on the right before data region.

Proposal 4: The current Physical control channels region should be replaced by this LAA sync.

1. A base station having a first cell in a licensed band and a second cell in an unlicensed band, comprising:
a controller configured to execute control to transmit a discovery reference signal in the second cell, wherein
the controller executes:
control to confirm whether or not there is an available channel in the unlicensed band, before transmitting the discovery reference signal; and
control to transmit the discovery reference signal in the available channel in the unlicensed band, and
the discovery reference signal includes a cell-specific reference signal, a primary synchronization signal, a secondary synchronization signal, and a channel-state-information reference signal.

2. A base station used in a mobile communication system comprising a user terminal capable of performing communication in a licensed band and an unlicensed band, comprising:
a controller configured to measure interference power in a predetermined frequency out of a plurality of frequencies available for data transmission and reception in the mobile communication system in the unlicensed band; and
a transmitter configured to transmit, based on a measurement result of the interference power, a reference signal, wherein
the unlicensed band includes the plurality of frequencies and an unused frequency other than the plurality of frequencies, and
the transmitter transmits the reference signal in the unused frequency.

3. A base station capable of performing communication, in an unlicensed band, with a user terminal capable of performing communication in a licensed band and the unlicensed band, wherein
the unlicensed band includes a plurality of frequency channels,
each of the plurality of frequency channels includes a plurality of frequency resources divided in a frequency direction,
the base station includes:
a controller configured to measure the interference power in a frequency resource unit; and
a transmitter configured to transmit, based on a measurement result of the interference power, a reference signal by using a predetermined frequency resource included in the plurality of frequency resources, and
the controller notifies the user terminal of resource information indicating the predetermined frequency resource.

4. A base station capable of performing communication, in a licensed band, with a user terminal capable of performing communication in the licensed band and an unlicensed band, comprising:
a controller configured to measure interference power in the unlicensed band; and
a transmitter configured to transmit, in the unlicensed band, a reference signal, wherein
the controller schedules a transmission timing of the reference signal at any timing.

5. The base station according to claim 4, wherein the controller notifies, in the licensed band, the user terminal of scheduling information indicating a transmission timing of the reference signal.
